(19) United States
(12) Patent Application Publication
(10) Pub. No.: US 2007/0005949 A1
(43) Pub. Date: Jan. 4, 2007

(54) Method for Booting a Computer System

(76) Inventors: Kuan-Jui Ho, Taipei Hsien (TW); Ming-Wei Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,602

(22) Filed: Sep. 16, 2005

(30) Foreign Application Priority Data
Jul. 1, 2005 (TW) 094122416

(51) Int. Cl. G06F 15/177

(52) U.S. Cl. 713/2

(57) ABSTRACT

A computer system has a processor, a basic input and output system (BIOS), a plurality of configurable hardware components, configuration data and an operating system (OS). The method includes executing the plurality of code segments from a starting point of the BIOS for initializing the plurality of hardware components, preparing to receive a configuration request, setting a program interrupt point, switching the computer into a user configuration mode for configuration request, continuing to execute the code segments by the program interrupt point, and loading the operating system.

### BACKGROUND OF THE INVENTION

1. Field of the Invention

The present invention relates to a method for booting a computer system, and more particularly, to a method for determining an execution point of a basic input and output system (BIOS) code segment according to system configuration data to simplify the boot procedure of the computer system.

2. Description of the Prior Art

In the modernized information society, computer systems have become one of the essential information tools. Typical computer systems include a desktop computer, a personal notebook computer, and a server.

When a power source of the computer system is switched on, the computer system will perform actions such as a power-on self-test (POST) and a plug-and-play test to a hardware configuration according a basic input and output system (BIOS) stored in a memory. After the above actions are completed, the computer system will then load an operating system that then coordinates the related hardware and software of the computer system to execute the functions of the computer system according to the settings of the BIOS.

Most computer systems allow the user to make changes for specific needs such as changing system time, setting input port IRQ or DMA values, setting whether to boot system setup with a memory cache, setting a boot sequence, and configuring a hardware setup. Data of these settings is stored into a memory device. When the personal computer is booted, a configuration data in the memory device is read so that a processor of the personal computer can execute the BIOS code segments to complete the boot action of the computer system according to the configuration data read. However those skilled in the art will know that after the user completes the setup action of the configuration data, whether or not the system settings have been changed, the computer system will always be reset and the BIOS code segments will be re-executed. Therefore under various conditions, the booting process of the conventional computer system proves to be ineffective, and the user's time is wasted having to wait for the computer to reboot.

Please refer to FIG. 1. FIG. 1 illustrates a flowchart of a conventional computer system when booted. When the user turns on a power switch of the computer system to boot the computer system (steps 10, 12), a processor of the computer system begins to read and execute BIOS code segments (step 14) to complete a basic hardware check. After the basic hardware check is completed, the computer system prepares to receive a configuration request (steps 16, 18) within a predetermined period of time (approximately several seconds), so that the user is allowed to input the above configuration request via a keyboard device. When the computer system receives the configuration request within the predetermined period of time, the computer system enters into a user configuration mode to allow the user to observe or change the BIOS configuration data (step 20). If the computer system does not receive the configuration request within the predetermined period of time, the processor of the computer system can continue to execute other BIOS code segments (step 22). Finally, an operating system is loaded (step 24) to complete the boot procedure of the computer system.

As shown in FIG. 1, after the user completes the setup action of the above configuration data (step 20), the computer system re-executes step 14 so that the processor can execute the BIOS program according to the configuration data after the completion of the system settings. Although, this can guarantee that the status of the computer system will conform to the user's setup after booting, this method of re-executing the BIOS code segment regardless of whether the system configuration data has been changed after the completion of step 20 is certainly not ideal.

### SUMMARY OF THE INVENTION

Therefore, the main objective of the claimed invention is to provide a method for booting a computer system to solve the above-mentioned problem.

The computer system comprises a processor for executing program codes, a basic input and output system (BIOS), a plurality of configurable hardware components, configuration data, a reference form, and an operating system (OS) for controlling operation of the computer system after booting. The BIOS comprises a plurality of code segments executable by the processor, the configuration data for configuring the plurality of hardware components, the reference form for recording a plurality of process configurations, wherein each process configuration records one status of the hardware components.

The method comprises executing the plurality of code segments from a starting point of the BIOS for initializing the plurality of hardware components, preparing to receive a configuration request, configuring a program interrupt point of the plurality of code segments, switching the computer system into a user configuration mode to set the configuration data when the configuration request is received, reading a corresponding process configuration from the reference form according to the configuration data after setting of the configuration data is completed, determining whether the program interrupt point or the starting point is to be the point of continued execution of the plurality of the code segments according to the process configuration read, and loading the operating system.

These and other objectives of the present invention will no doubt be known to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of booting a conventional computer system.

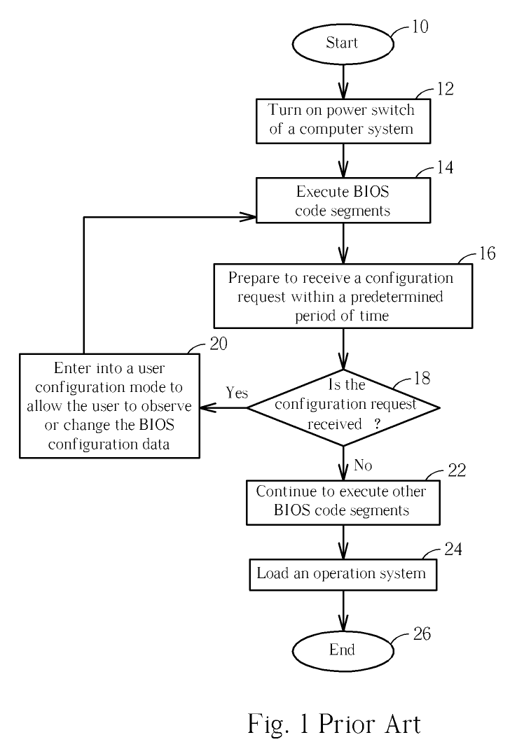

FIG. 2 illustrates a functional block diagram of a computer system according to the present invention.

FIG. 3 illustrates a memory map diagram of the BIOS in FIG. 2.

FIG. 4 illustrates a data structure diagram of the reference form of FIG. 2.

FIG. 5 illustrates a flowchart of a method according to the present invention.

FIG. 6 illustrates a flowchart of a method according to another embodiment of the present invention.

### DETAILED DESCRIPTION

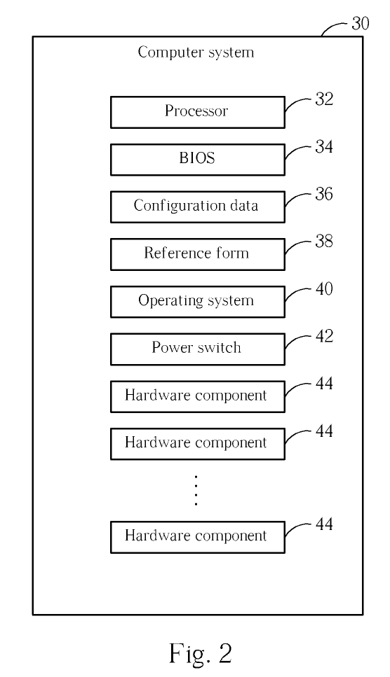

Please refer to FIG. 2. FIG. 2 illustrates a functional block diagram of a computer system 30 according to a method of the present invention. The computer system 30 comprises a processor 32 for executing program code, a basic input and output system (BIOS) 34, configuration data 36, a reference form 38, an operating system (OS) 40 for controlling operations of the computer system 30 after booting, a power switch 42, and a plurality of configurable hardware components 44. The above-mentioned plurality of hardware components 44 include registers and control circuits of each piece of hardware in the computer system 30 which can be configured according to the configuration data 36. In the present embodiment, the configuration data 36 is generally stored in a complementary metal oxide semiconductor (CMOS) chip on a motherboard of the computer system 30 for recording related system configuration data of the computer system 30. Such related system configuration data can include memory access mode, power control setup, processor clock, bus clock, processor operation frequency multiplication setup, IRQ and DMA value settings of each input and output port, plug-and-play mode, boot sequence, and so on.

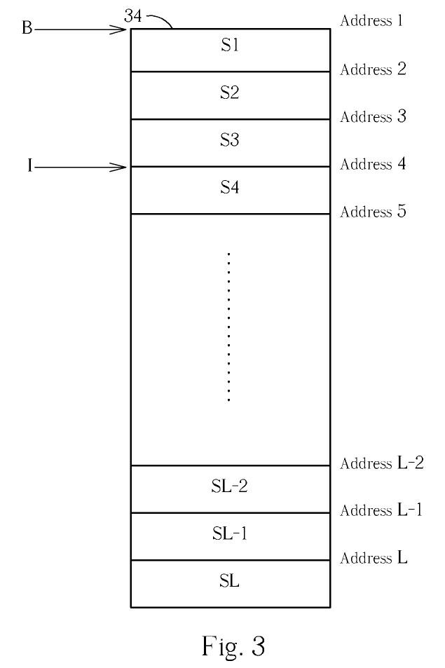

Please refer to FIG. 3. FIG. 3 illustrates a memory map diagram of the BIOS 34 in FIG. 2. The BIOS 34 comprises a plurality of code segments S1, S2, S3 . . . SL. Each code segment has a specific function and is stored within the corresponding memory address. For example, the code segment S2 is stored in between address 2 and address 3 of the memory. After power is turned on in the computer system 30, the processor 32 reads the suitable code segment from the BIOS 34 for further executing the related setup and activation of related hardware devices of the computer system 30. Finally the operating system 34 is loaded and the boot procedure is completed.

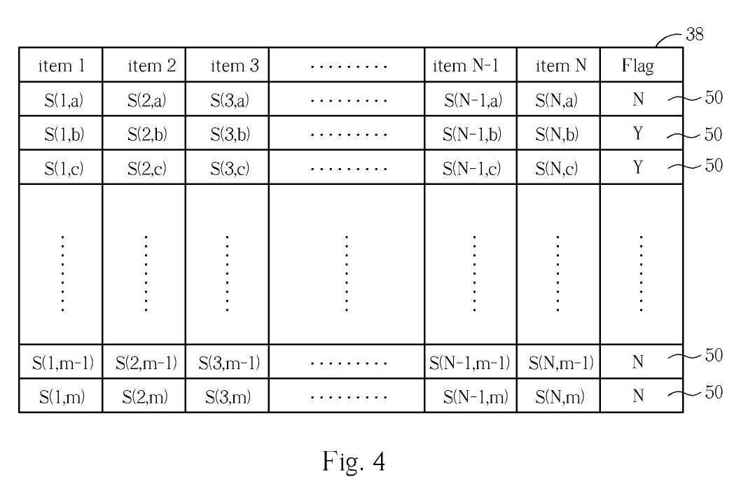

Please refer to FIG. 4. FIG. 4 illustrates a data structure diagram of the reference form 38 of FIG. 2. The reference form 38 records a plurality of process configurations 50, and each process configuration 50 records a status S(1, x)˜S(N, x) of the above-mentioned plurality of hardware components 44. The variable N is a total number of the configurable hardware components 44 in the computer system 30, the variable x represents the process configuration 50 located in a line of the reference form 38, and a variable m in FIG. 4 represents a total data of the process configuration 50 of the reference form 38. Each process configuration 50, in addition to recording the status of each hardware component 44, records a flag value Flag for controlling an execution flow of the code segments of the BIOS 34. This will be explained later. Furthermore, the status S(1,x)˜S(N,x) of the hardware component 44 recorded by each process configuration 50 can be a null value, but not all the statuses S(1,x)˜S(N,x) can be simultaneously null and therefore each process configuration 50 records at least one status of the hardware component 44. When the setup procedure of the configuration data 36 is completed, the computer system 30 can determine a starting point of the BIOS 34 executed by the processor 32 according to the hardware component status S(1,x)˜S(N,x).

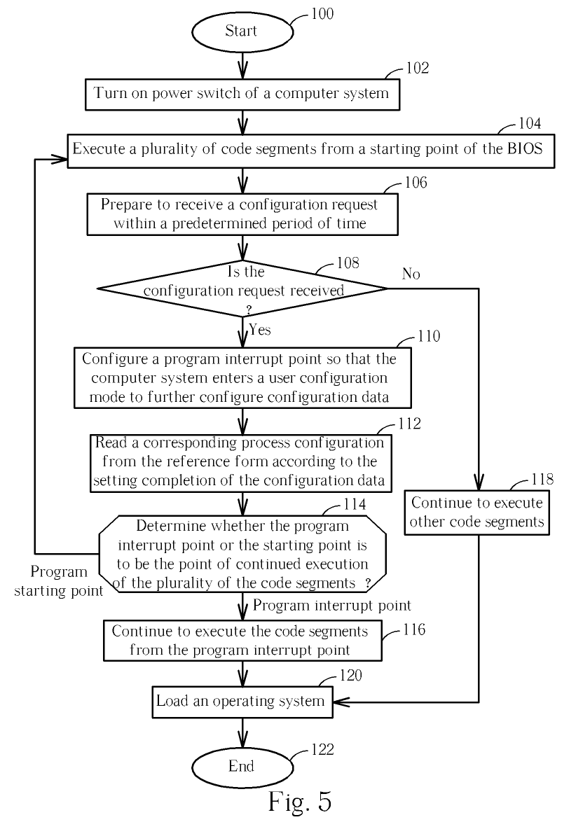

Please refer to FIG. 5. FIG. 5 illustrates a flowchart of a method according to the present invention. The method comprises the following steps:

Step 100: Start;

Step 102: Utilize the power switch 42 to turn on power for the computer system 30. If power for the computer system 30 has already been turned on (for example, a reset button is pressed by a user), this step can be skipped;

Step 104: Execute a plurality of code segments S1˜SL from a starting point B of the BIOS 34 to initialize the hardware components 44, wherein the starting point B is usually a smallest address (address 1) of the code segment recorded in the BIOS 34;

Step 106: Prepare to receive a configuration request within a predetermined period of time, wherein the configuration request is further input by the user via an input device (such as a keyboard) of the computer system 30;

Step 108: Determine whether the computer system receives the configuration request within the predetermined period of time. If the configuration request is received within the predetermined period of time, proceed to step 110; if no configuration request is received, proceed to step 118;

Step 110: Configure a program interrupt point I so that the computer system 30 enters a user configuration mode to further configure configuration data 36. In this embodiment, when the program interrupt point I terminates at step 106, the processor 32 continues to execute a memory address of the code segment. If no configuration request is received by the computer system 30 within the predetermined period of time, the processor 32 will continue to execute the code segment of the BIOS 34 from the program interrupt point I;

Step 112: End setting action of the configuration data 36 and read a corresponding process configuration 50 from the reference form 38 according to the setting completion of the configuration data 36;

Step 114: Determine whether the program interrupt point I or the starting point B is to be the point of continued execution of the plurality of the code segments S1˜SL according to the flag value Flag recorded the process configuration 50. If the flag value Flag recorded in the process configuration 50 read is “N”, then the processor 32 continues to execute the code segments S1˜SL from the program interrupt point 1. If the flag value Flag recorded in the process configuration 50 read is “Y”, then the processor 32 will re-execute the code segments S1˜SL from the starting point B. If the code segments S1˜SL are to be re-executed from the starting point B, re-execute step 104. If the code segments S1˜SL are needed to be re-executed from the program interrupt point 1, then proceed to step 116;

Step 116: Continue to execute the code segments S1˜SL from the program interrupt point 1, the code segments executed (for example code segments S1˜S3) will not be executed again;

Step 118: Continue to execute other code segments (for example code segments S4˜SL);

Step 120: Load an operating system 40 so that the operating system 40 can control operations of the computer system 30 after booting;

Step 122: End.

From the above-mentioned flowchart of the present invention, the difference between the present invention and the procedure of booting in the conventional computer system is that the method of the present invention includes a step of comparing the reference form 38, after the completion of the setting action of the configuration data 36, a suitable process configuration 50 is selected and read according to the configuration data 36. The processor 32 determines from which memory address the code segment is being read for further execution according to the flag value Flag recorded in the process configuration 50. Therefore, when the computer system 30 ends the setting of the configuration data 36, if there is no change in the configuration data 36 or any change that will not affect the accuracy and stability of the processor 32 in further executing the code segment, then the flag value Flag can be set as “N” so that the processor 32 can continue to execute the code segments S3˜SL that are not yet executed from the program interrupt point I. In this way, time wasted in rebooting the computer system 30 can be saved. Furthermore, from the above-mentioned we can know that if no configuration request is received by the computer system 30 within the predetermined period of time, the processor 32 will continue to execute the code segment of the BIOS 34 from the program interrupt point I, which means that the computer system 30 will neglect any configuration request outside the predetermined period of time.

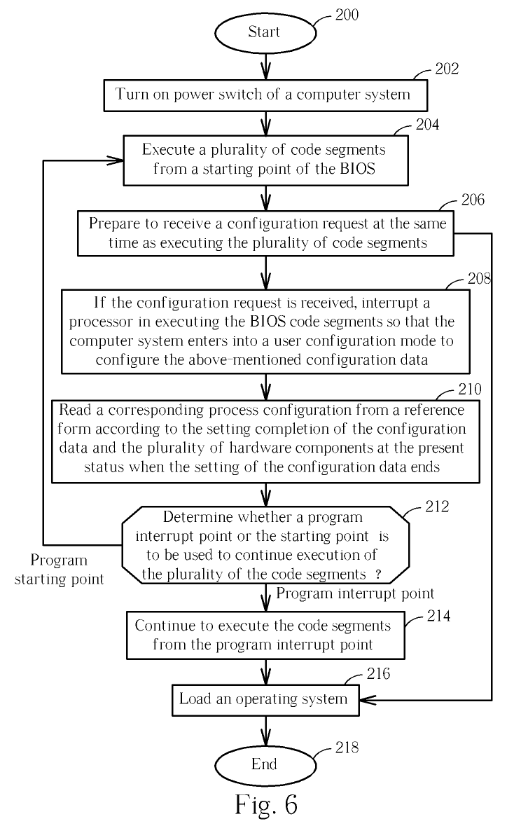

Please refer to FIG. 6. FIG. 6 illustrates a flowchart of a method according to another embodiment of the present invention. The method comprises the following steps:

Step 200: Start;

Step 202: Utilize the power switch 42 to turn on power for the computer system 30;

Step 204: Execute the plurality of code segments S1˜SL from the starting point B of the BIOS 34 to initialize the plurality of hardware components 44;

Step 206: Prepare to receive a configuration request at the same time as executing the plurality of code segments S1˜SL;

Step 208: Interrupt a processor 32 in executing the BIOS 34 code segments S1˜SL so that the computer system 30 enters into a user configuration mode to configure the above-mentioned configuration data 36;

Step 210: Read a corresponding process configuration 50 from a reference form 38 according to the setting completion of the configuration data 36 and the plurality of hardware components 44 at the present status when the setting of the configuration data 36 ends;

Step 212: Determine whether a program interrupt point I or the starting point B is to be used to continue execution of the plurality of the code segments S1˜SL according to the process configuration 50 read. If the code segments S1˜SL are to be executed from the program interrupt point I, then proceed to step 214. If the code segments S1˜SL are to be executed from the starting point B, then proceed to step 204;

Step 214: Continue to execute the code segments S1˜SL from the program interrupt point I;

Step 216: Load an operating system 40;

Step 218: End.

From the above-mentioned flowchart, the differences between the method of this embodiment and the method of the previous embodiment are that (1) before loading the code segment of the BIOS 34 executed by the processor 32 into the operating system 40, the user can at anytime input a configuration request to allow the computer system 30 to enter the user configuration mode to configure the configuration data 36; and (2) the process configuration 50 can be further selected according to the setting completion of the configuration data 36 and the plurality of hardware components 44 at the present status, hence, the determining condition when selecting the process configuration becomes more varied.

In comparison with the conventional computer system, the method of the present invention determines the execution point of the code segment of the BIOS according to the setting completion of the configuration data and the plurality of hardware components at the present status. Under certain circumstances, the boot procedure of the computer system can be simplified after the computer system completes the system configuration.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for booting a computer system, the computer comprising:
a processor for executing program code;
a basic input and output system (BIOS) comprising a plurality of code segments;
a plurality of configurable hardware components;
configuration data for configuring the plurality of hardware components;
a reference form for recording a plurality of process configurations, wherein each process configuration records one status of the hardware components; and
an operating system (OS) for controlling operation of the computer system after booting;
the method comprising:
(a) executing the plurality of code segments from a starting point of the BIOS for initializing the plurality of hardware components;
(b) preparing to receive a configuration request;
(c) configuring a program interrupt point of the plurality of code segments;
(d) switching the computer system into a user configuration mode to set the configuration data when the configuration request is received;
(e) reading a corresponding process configuration from the reference form according to the configuration data, after setting of the configuration data is completed;
(f) determining whether the program interrupt point or the starting point is to be the point of continued execution of the plurality of the code segments according to the process configuration read in step (e); and
(g) loading the operating system.

2. The method of claim 1 wherein when step (e) is performed, the corresponding process configuration is read from the reference form according to the set configuration data and the plurality of hardware components at a present status.

3. The method of claim 1 wherein the program interrupt point is further configured when step (d) is performed.

4. The method of claim 1 further comprising:
(h) preparing to receive the configuration request within a predetermined period of time; and
(i) neglecting all configuration requests outside the predetermined period of time.

5. The method of claim 1 further comprising:
(j) allowing the computer system to perform step (d) before loading the operating system in step (g).

6. The method of claim 1 wherein the computer system further comprises a power switch for controlling the on and off operation of the computer system, the method further comprising:
(k) utilizing the power switch to turn on power for the computer system.

7. The method of claim 1 wherein the starting point and the program interrupt point are two different execution points of the plurality of code segments.

8. A method for booting a computer system, the computer comprising:
a processor for executing program code;
a basic input and output system (BIOS) comprising a plurality of code segments;
a plurality of configurable hardware components;
configuration data for configuring the plurality of hardware components;
an operating system (OS) for controlling operation of the computer system after booting;
the method comprising:
(a) executing the plurality of code segments from a starting point of the BIOS for initializing the plurality of hardware components;
(b) preparing to receive a configuration request;
(c) configuring a program interrupt point of the plurality of code segments;
(d) switching the computer system into a user configuration mode to set the configuration data when the configuration request is received;
(e) executing the plurality of the code segments from the program interrupt point when setting of the configuration data is completed; and
(f) loading the operating system.

9. The method of claim 8 wherein the computer system further comprises a reference form, the reference form records a plurality of process configurations, and each process configuration records one status of the hardware components, the method further comprising:
(g) reading a corresponding process configuration from the reference form after the setting of the configuration data is completed according to the configuration data; and
(h) determining whether the program interrupt point or the starting point is to be the point of continued execution of the plurality of the code segments according to the process configuration read in step (g).

10. The method of claim 9 wherein when step (g) is performed, the corresponding process configuration is read from the reference form according to the completion of the setting of the configuration data and the plurality of hardware components of a present status.

11. The method of claim 8 wherein the program interrupt point is further configured when step (d) is performed.

12. The method of claim 8 further comprising:
(i) preparing to receive the configuration request within a predetermined period of time; and
(j) neglecting all configuration requests outside the predetermined period of time.

13. The method of claim 8 further comprising:
(k) allowing the computer system to perform step (d) before loading the operating system in step (f).

14. The method of claim 8 wherein the computer system further comprising a power switch for controlling the on and off operation of the computer system, the method further comprising:
(l) utilizing the power switch to turn on power for the computer system.

15. The method of claim 8 wherein the starting point and the program interrupt point are two different execution points of the plurality of code segments.

16. A method of booting a computer system, the computer system having a BIOS and configuration data, wherein the BIOS contains a plurality of code segments which are cooperated with configuration data for initializing a plurality of hardware components, the method comprising:
executing the plurality of code segments sequentially;
interrupting the execution of code segments and receiving a new set of configuration data in response to a setting request; and
continuing to execute the remaining code segments if the new set of configuration data does not affect the initialization of hardware components.

17. The method of claim 16 wherein the setting request is received in a predetermined time period.

18. The method of claim 16 wherein the computer system further comprises a reference form for recording process information, the process information records statuses of the hardware components being utilized to determine the affection of the initialization of hardware components.

19. An apparatus for booting a computer system, the computer system having a BIOS and configuration data, wherein the BIOS contains a plurality of code segments which are cooperated with configuration data for initializing a plurality of hardware components, the apparatus comprising:
executing the plurality of code segments sequentially;
interrupting the execution of code segments and receiving a new set of configuration data in response to a setting request; and
continuing to execute the remaining code segments if the new set of configuration data does not affect the initialization of hardware components.
